(19) United States
(12) Patent Application Publication
(10) Pub. No.: US 2024/0361716 A1
(43) Pub. Date: Oct. 31, 2024

(54) FIXING DEVICE AND IMAGE FORMING APPARATUS

(71) Applicant: KYOCERA Document Solutions Inc., Osaka-shi (JP)

(72) Inventors: Rina Kikugawa, Osaka (JP); Ryohei Tokunaga, Osaka (JP); Akihiro Kondo, Osaka (JP); Yuta Kitabayashi, Osaka (JP); Hiroki Kawasaki, Osaka (JP); Shunsaku Fujii, Osaka (JP); Yuto Masaoka, Osaka (JP)

(21) Appl. No.: 18/648,284

(22) Filed: Apr. 26, 2024

(30) Foreign Application Priority Data
Apr. 27, 2023 (JP) 2023-073225

(51) Int. Cl. G03G 15/20

(52) U.S. Cl. CPC G03G 15/2053; G03G 15/2064; G03G 2215/2035

(57) ABSTRACT

The fixing device includes: a rotatable endless fixing belt; a heater that heats the fixing belt; a holding member that holds the heater so that a front surface thereof is in contact with an inner peripheral surface of the fixing belt; and a pressure member that is pressed against the heater with the fixing belt therebetween and to form a pressure area between the pressure member and the fixing belt where a sheet to which a toner image has been transferred is heated and pressed. A uniform heating layer is formed on a rear side of the heater without any gaps.

### INCORPORATION BY REFERENCE

This application is based upon and claims the benefit of priority from the corresponding Japanese Patent Application No. 2023-073225 filed on Apr. 27, 2023, the entire contents of which are incorporated herein by reference.

### BACKGROUND

The present disclosure relates to a fixing device that fixes a toner image to a sheet, and an image forming apparatus equipped with this fixing device.

A sliding type fixing device includes an endless fixing belt that is heated by a heater, and a pressure member that comes in contact with the fixing belt to form a pressure area. The fixing device fixes the toner image to a sheet conveyed to the pressure area by rotating the fixing belt and the pressure member. In such a fixing device, it is necessary to make a temperature distribution of the fixing belt uniform in order to eliminate uneven fixing.

A known fixing device includes a heat conductive member that comes in contact with a surface of the heater opposite to a surface that comes in contact with a film. The film corresponds to the fixing belt. The heat conductive member is sandwiched between the heater and a support member that supports the heater so as to be in continuous contact with the heater from a center portion to an end portion of the heat generating area of the heater.

However, in known fixing devices, the heat conductive member is simply sandwiched between the heater and a supported member, and thus a contact state between the heat conductive member and the heater may not be constant in a width direction of the fixing belt, and there is a possibility that a sufficient heat uniformity effect cannot be obtained in the width direction.

### SUMMARY

The fixing device according to the present disclosure includes: a rotatable endless fixing belt; a heater configured to heat the fixing belt; a holding member configured to hold the heater so that a front surface thereof is in contact with an inner peripheral surface of the fixing belt; and a pressure member configured to be pressed against the heater with the fixing belt therebetween and to form a pressure area between the pressure member and the fixing belt where a sheet to which a toner image has been transferred is heated and pressed; wherein a uniform heating layer is formed on a rear side of the heater without any gaps.

According to the present disclosure, the uniform heating layer may be formed by vapor depositing carbon on a rear surface of the heater.

According to the present disclosure, the uniform heating layer may be formed to be thicker at a location where a temperature of the fixing belt is desired to be increased than at a location other than that location.

According to the present disclosure, the heater may include a plurality of resistance heating elements divided in a width direction of the fixing belt; and the location where the temperature of the fixing belt is desired to be increased may be a location between adjacent resistance heating elements.

According to the present disclosure, the fixing device may further include a temperature sensor configured to measure a temperature of the heater; and the location where the temperature of the fixing belt is desired to be increased may be a location where the temperature sensor comes in contact with the heater.

An image forming apparatus according to the present disclosure includes: an image forming portion configured to form a toner image on a sheet; and the fixing device described above configured to fix the toner image to the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a front view schematically showing an internal configuration of an image forming apparatus of an embodiment according to the present disclosure.

FIG. 2 is a cross-sectional view schematically showing an internal configuration of a fixing device of an embodiment according to the present disclosure.

FIG. 3 is a side view showing a heater of a fixing device of an embodiment according to the present disclosure.

FIG. 4 is a plan view showing a heater of a fixing device of an embodiment according to the present disclosure.

FIG. 5 is a plan view showing another example of a heater of a fixing device of an embodiment according to the present disclosure.

FIG. 6 is a plan view showing another example of a heater of a fixing device of an embodiment according to the present disclosure.

### DETAILED DESCRIPTION

Hereinafter, an image forming apparatus and a fixing device according to the present disclosure will be described with reference to the drawings.

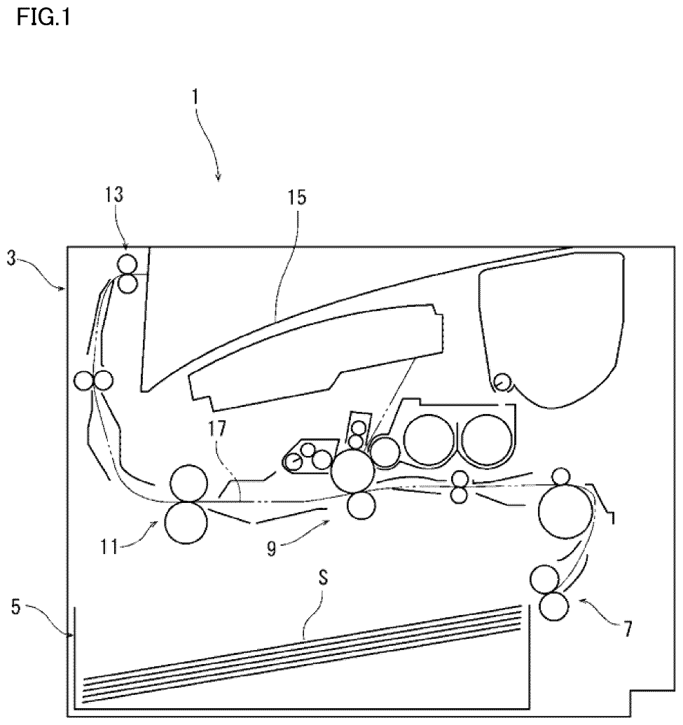

First, an overall configuration of an image forming apparatus 1 will be described using FIG. 1. FIG. 1 is a front view schematically showing an internal configuration of the image forming apparatus 1. Hereinafter, a front side of a sheet in FIG. 1 will be referred to as a front side of the image forming apparatus 1.

A main body 3 of the image forming apparatus 1 includes a sheet feed cassette 5 that accommodates sheets S, a sheet feed device 7 that feeds a sheet S from the sheet feed cassette 5, an image forming portion 9 that forms a toner image on a sheet S using an electrophotographic method, a fixing device 11 that fixes a toner image on a sheet S, a sheet discharge device 13 that discharges a sheet S, and a sheet discharge tray 15 on which discharged sheets S are stacked.

Furthermore, in the main body 3 of the apparatus, a conveying path 17 for conveying a sheet S is formed starting from the sheet feed device 7, passing through the image forming portion 9 and the fixing device 11, and heading toward the sheet discharge device 13.

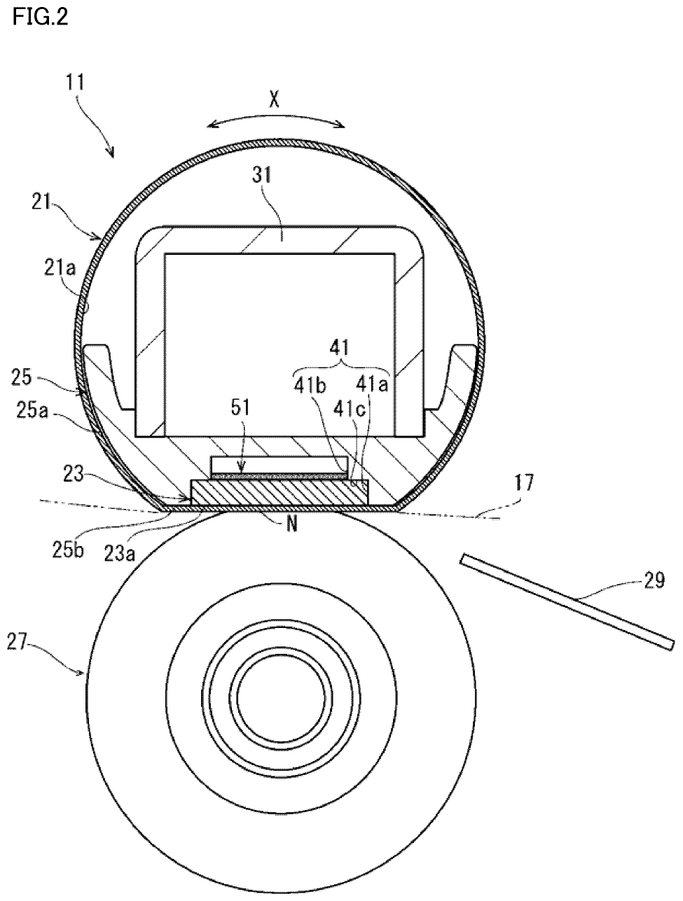

Next, the fixing device 11 will be explained with reference to FIG. 2. FIG. 2 is a cross-sectional view of the fixing device 11.

As shown in FIG. 2, the fixing device 11 includes a fixing belt 21, a heater 23 that heats the fixing belt 21, a holding member 25 that holds the heater 23, a pressure roller 27 as a pressure member that forms a pressure area N between the fixing device 11 and the fixing belt 21, and a guide 29 that guides a sheet S to the pressure area.

The fixing belt 21 is an endless belt, and has a predetermined inner diameter and a width longer than a width of a sheet S. The fixing belt 21 is made of a flexible material. The fixing belt 21 includes a base material layer, an elastic layer provided on an outer peripheral surface of the base material layer, and a release layer provided on an outer peripheral surface of the elastic layer.

The base material layer is made of metal such as SUS or Ni. The elastic layer is made of silicone rubber or the like. The release layer is made of a PFA tube or the like. A sliding layer may be formed on an inner peripheral surface of the base material layer. The sliding layer is made of polyimide amide, PTFE, or the like.

Both end portions of the fixing belt 21 are supported by end holders (not shown). Both end holders are rotatably supported by a fixing housing (not shown). In addition, a stay 31 passes through a hollow portion of the fixing belt 21. Both end portions of the stay 31 are supported by the fixing housing.

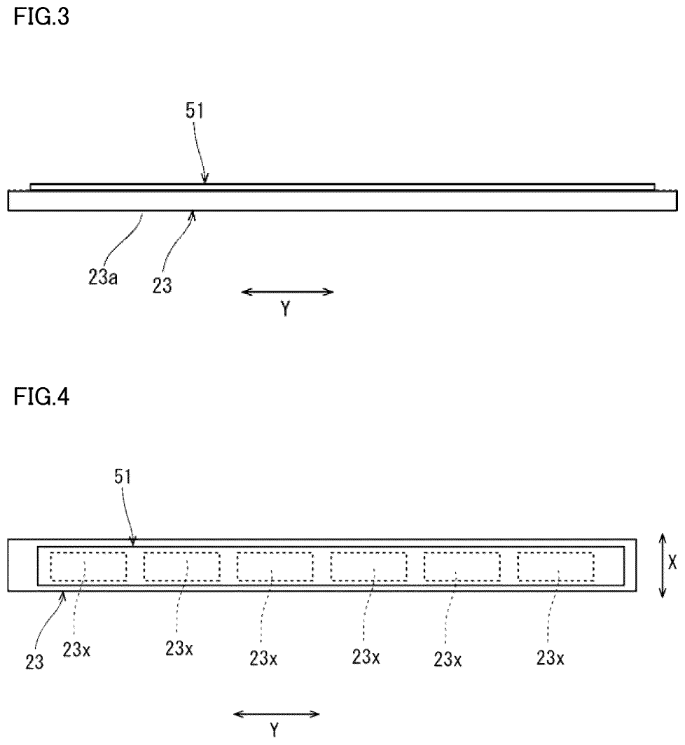

Next, the heater 23 will be explained with reference to FIGS. 3 and 4. FIG. 3 is a side view showing the heater 23, and FIG. 4 is a plan view showing the heater 23.

The heater 23 is a flat member, and has a width equivalent to a width of the fixing belt 21 (length along a width direction Y intersecting a circumferential direction X), and has a predetermined length and thickness. The heater 23 includes a substrate made of stainless steel or ceramic, an electrical insulating layer made of glass or the like, a resistance heating element layer, and a protective layer, which are laminated in order from a rear side to a front side.

As shown in FIG. 4, the resistance heating element layer has a plurality of resistance heating elements 23x arranged in the width direction Y. A surface of the protective layer is formed flat and serves as a sliding surface 23a that comes in contact with the inner peripheral surface 21a of the fixing belt 21. The resistive heating element layer generates heat by supplying electricity to the resistive heating element layer through the electrode.

A uniform heating layer 51 having a constant thickness is formed on the rear surface of the heater 23 (the surface of the substrate). The uniform heating layer 51 is created, for example, by vapor depositing carbon with high electrical conductivity. The uniform heating layer 51 is formed on a rear side of the heater 23 at a portion other than both ends in the width direction Y and both ends in the circumferential direction X.

As shown in FIG. 2, the holding member 25 is a substantially semi-cylindrical member, and has a width equivalent to the width of the fixing belt 21 and a predetermined length along the circumferential direction X. The holding member 25 is made of, for example, a heat-resistant resin such as a liquid-crystal polymer.

An outer peripheral surface 25a of the holding member 25 is curved along the inner peripheral surface 21a of the fixing belt 21. An outer peripheral surface of a top portion 25b of the holding member 25 is formed flat. A recessed portion 41 for accommodating the heater 23 is formed along the width direction Y in the top portion 25b.

The recessed portion 41 has an outer-side recessed portion 41a having a long length in the circumferential direction X, and an inner-side recessed portion 41b having a shorter length in the circumferential direction X than the outer-side recessed portion 41a. Seat surfaces 41c parallel to an outer peripheral surface of the top portion 25b of the holding member 25 are formed on both sides of the inner recess 41b in the circumferential direction X.

The heater 23 is accommodated in the outer-side recessed portion 41a. The sliding surface 23a of the heater 23 is flush with the outer peripheral surface of the top portion 25b of the holding member 25.

The rear surface of the heater 23 is in contact with the seat surface 41c of the recessed portion 41. On the other hand, the uniform heating layer 51 formed on the rear surface of the heater 23 does not come in contact with the seat surface 41c.

The pressure roller 27 includes a metal core, an elastic layer provided on an outer peripheral surface of the metal core, and a release layer provided on an outer peripheral surface of the elastic layer. The elastic layer is made of silicone rubber or the like. The release layer is formed of a PFA tube or the like.

The pressure roller 27 is supported so as to be pressed against the heater 23 from below the fixing belt 21. Thus, a pressure area N is formed between the fixing belt 21 and the pressure roller 27.

The pressure roller 27 is driven by a motor (not shown) and rotates in the counterclockwise direction in FIG. 2. When the pressure roller 27 is driven by a motor and rotates, the fixing belt 21 is driven to rotate in the clockwise direction in FIG. 2, which is opposite to the direction of the pressure roller 27. Thus, the sheet S passes through the pressure area N.

The guide 29 is arranged farther on an upstream side in a conveying direction of the sheet S than the pressure area N, and guides the sheet S conveyed along the conveying path 17 to the pressure area N.

A fixing operation of the fixing device 11 having the above configuration will be explained. First, the pressure roller 27 is driven by a motor and rotates, and the fixing belt 21 is driven by the pressure roller 27 in a direction (clockwise direction in FIG. 2) opposite to the rotation direction of the pressure roller 27. At the same time, the heater 23 is driven to heat the fixing belt 21.

The fixing belt 21 is heated until reaching a predetermined control temperature (for example, 160° C.). After the fixing belt 21 is heated in this manner, the sheet S on which the toner image has been transferred is guided by the guide 29 and conveyed to the pressure area N.

When the sheet S passes through the pressure area N, the sheet S is heated by the fixing belt 21 and is also pressed by the pressure roller 27 and the fixing belt 21, so that the toner image is fixed to the sheet S. The sheet S to which the toner image has been fixed is conveyed from the pressure area N along the conveying path 17.

As described above, with the fixing device 11 according to the present disclosure, the heat emitted from the resistance heating elements 23x of the heater 23 is transmitted in the width direction Y via the uniform heating layer 51, and thus the temperature of the heater 23 in the width direction Y can be made uniform.

Therefore, the fixing belt 21 can be heated to a constant temperature in the width direction Y. Furthermore, the uniform heating layer 51 is formed on the heater 23 without any gaps, and thus a constant uniform heating effect can be obtained in the width direction Y.

In the embodiment described above, the uniform heating layer 51 is created by carbon vapor deposition; however, the uniform heating layer 51 may also be created by applying a metal paste to a surface on a rear side of the heater 23.

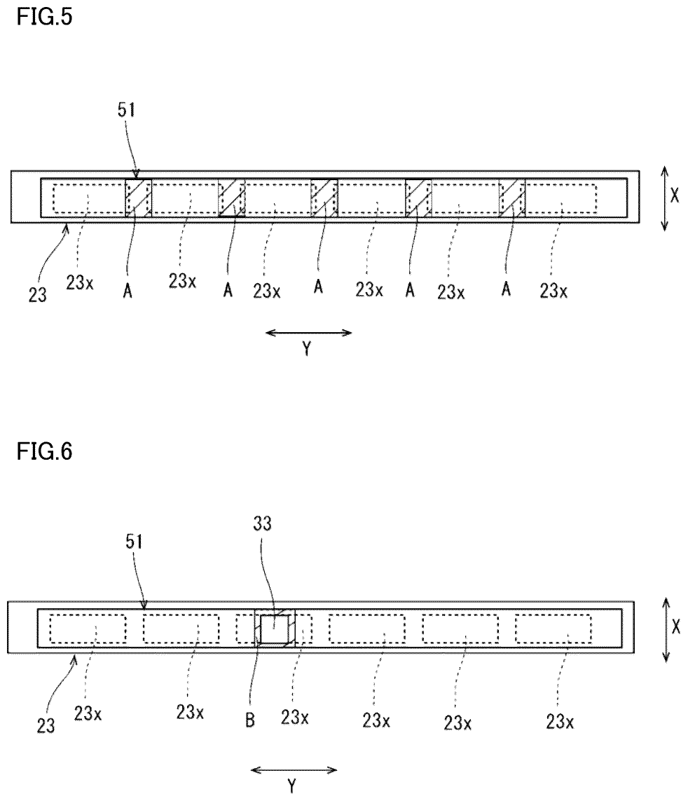

Next, the heater 23 of the fixing device 11 of another example according to the present disclosure will be described with reference to FIGS. 5 and 6. FIGS. 5 and 6 are plan views showing the heater 23.

In the example shown in FIG. 5, the uniform heating layer 51 is formed thicker in a portion between adjacent resistance heating elements 23x than in other portions. There is no resistance heating element 23x in an area between adjacent resistance heating elements 23x (portion A indicated by hatching in FIG. 5), and thus the temperature does not easily rise. Therefore, the temperature distribution in the width direction Y may not be uniform in some cases.

Therefore, by increasing the thickness of the uniform heating layer 51 in the portion A between the adjacent resistance heating elements 23x, it becomes easier for heat to move to this portion, and the temperature distribution in the width direction Y can be made uniform.

In the example shown in FIG. 6, a temperature sensor 33 that measures the temperature of the heater 23 is provided. The temperature sensor 33 is a thermistor, a thermocut, or the like, and is supported by a stay 31 and comes into contact with the rear surface of the heater 23 through a through hole formed in the holding member 25.

The uniform heating layer 51 is formed to be thicker at a contact location between the temperature sensor 33 and the heater 23 (portion B indicated by hatching in FIG. 6) than at other locations.

When the temperature sensor 33 and the heater 23 are in contact, the heat emitted from the heater 23 moves not only to the fixing belt 21 but also to the temperature sensor 33. Therefore, the temperature of the fixing belt 21 does not easily rise at the contact location B between the temperature sensor 33 and the heater 23.

Therefore, by increasing the thickness of the uniform heating layer 51 at the contact location B between the temperature sensor 33 and the heater 23, heat can easily move to the contact location B, and the temperature distribution in the width direction Y can be made uniform.

Furthermore, the above description of the embodiments according to the present disclosure describes preferred embodiments according to the present disclosure, and although various technically preferable limitations may be added, the technical scope of the present disclosure is not limited to these aspects unless there is a statement that specifically limits the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device comprising:
a rotatable endless fixing belt;
a heater configured to heat the fixing belt;
a holding member configured to hold the heater so that a front surface thereof is in contact with an inner peripheral surface of the fixing belt; and
a pressure member configured to be pressed against the heater with the fixing belt therebetween and to form a pressure area between the pressure member and the fixing belt where a sheet to which a toner image has been transferred is heated and pressed; wherein
a uniform heating layer is formed on a rear side of the heater without any gaps.

2. The fixing device according to claim 1, wherein the uniform heating layer is formed by vapor depositing carbon on a rear surface of the heater.

3. The fixing device according to claim 1, wherein the uniform heating layer is formed to be thicker at a location where a temperature of the fixing belt is desired to be increased than at a location other than that location.

4. The fixing device according to claim 3, wherein
the heater comprises a plurality of resistance heating elements divided in a width direction of the fixing belt; and
the location where the temperature of the fixing belt is desired to be increased is a location between adjacent resistance heating elements.

5. The fixing device according to claim 3, further comprising
a temperature sensor configured to measure a temperature of the heater; and
the location where the temperature of the fixing belt is desired to be increased is a location where the temperature sensor comes in contact with the heater.

6. An image forming apparatus comprising:
an image forming portion configured to form a toner image on a sheet; and
the fixing device according to claim 1 configured to fix the toner image to the sheet.
